(19) United States
(12) Patent Application Publication
(10) Pub. No.: US 2003/0016320 A1
(43) Pub. Date: Jan. 23, 2003

(54) Cholesteric color filter

(75) Inventors: Ciska Doornkamp, Eindhoven (NL); Rene Theodorus Wegh, Eindhoven (NL); Johan Lub, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/191,445

(22) Filed: Jul. 9, 2002

(30) Foreign Application Priority Data
Jul. 17, 2001 (EP) 01202717.3

(51) Int. Cl. G02F 1/1335

(52) U.S. Cl. 349/106

(57) ABSTRACT

The present invention relates to a cholesteric color filter (CCF) provided with a coating preventing the ingress of oxygen, and a method for making such a cholesteric color filter. It further relates to a device, such as a liquid crystal display (LCD), comprising a substrate provided with such a cholesteric color filter. The topcoat is preferably curable by electromagnetic radiation.

The present invention relates to a cholesteric color filter, a device comprising such and a method of manufacturing such filter.

The market share of liquid crystal displays (LCD) is continuously increasing at the cost of other display technologies. In order to provide colors, color filters are used. Conventionally, absorbing color filters are used, wherein colors are generated by absorbing two of the three primary colors. Such a color filter is e.g. disclosed in EP 0 572 089.

However, in particular with respect to the use of LCDs for portable applications like cellular telephones and for demanding applications like PDAs, low cost and low power are equally important as display image quality. To this end, such display panels based on cholesteric color filters has recently been developed, and forms an attractive alternative for absorbing color filters. Cholesteric color filters could combine a reflector function, a polarizer function and a color filter function. However, for some applications, transmissive cholesteric color filters could be used as well. Cholesteric color filters are generally simpler and less expensive to produce than absorbing color filters.

For example, a cholesteric liquid crystal layer for selectively reflecting circularly polarized light having a specific wavelength is disclosed in WO 00/34808.

However, in attempts to manufacture an LCD comprising such a cholesteric color filter the cholesteric color filter proved to lack stability apparently against the conditions of manufacturing.

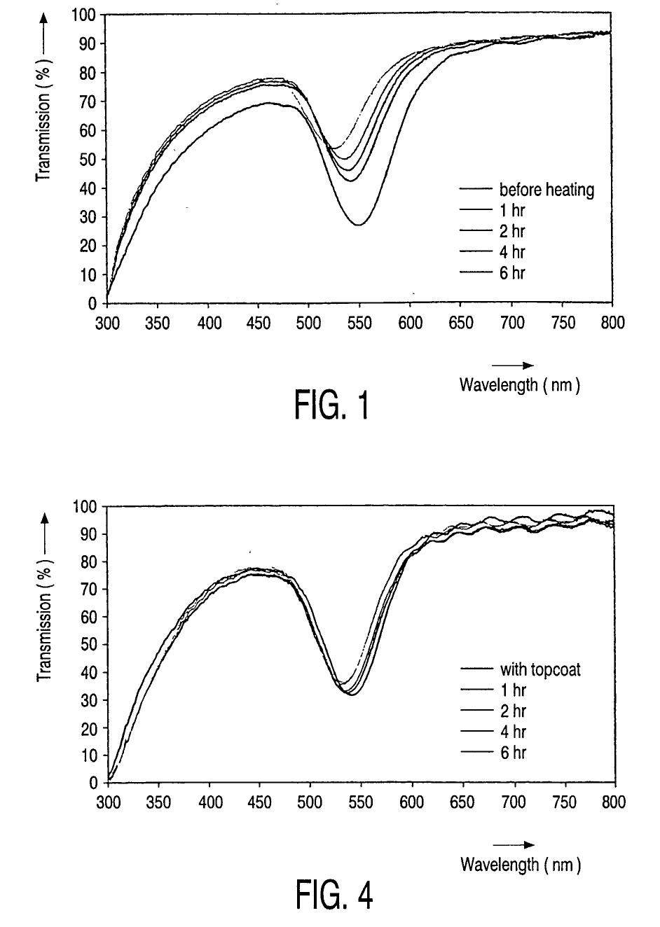

Experiments performed by the inventors which are an essential part of the present invention showed that heating the cholesteric color filter at temperatures higher than 150° C. results in a dramatic change of the performance of the cholesteric color filter. In the diagram in FIG. 1 the transmission spectra of a cholesteric color filter (CCF) heated at 200° C. during different time periods is illustrated. In FIG. 1, the lowermost curve with the greatest thickness indicates the transmission spectra for the CCF before heating, whereas the higher and thinner curves in order represents the transmission spectra for CCFs heated 1 hr, 2 hr, 4 hr and 6 hr, respectively. Due to the heating, the wavelength of the reflected light is shifted to lower wavelengths and also the intensity of the reflected light is severely decreased.

However, the manufacture of liquid crystal displays involves many such high temperature steps, in particular between 180 and 250° C.

After generation of the colors, the cholesteric layer is stabilized by a polymerization reaction. Although the cross-link density of the system after polymerization is quite high, which as such should result in high temperature resistance this does not prevent the cholesteric color filter from changing during a temperature treatment.

It is therefore an object of the present invention to provide a more stable cholesteric color filter.

This object is achieved with a device and a method as defined in the appended claims.

The invention relates to a cholesteric color filter (CCF) provided with a coating preventing the ingress of oxygen.

The invention is based on the realization made by the present inventors, that the shift of the wavelength and the decrease of the reflected intensity of the cholesteric color filter during heating is caused by oxidation of isomerisable dopant of the color filter during heating, followed by evaporation of reaction products as confirmed by GC-MS analysis. As a result, the structures and orientation of the layer is changed leading to a value shift of the wavelength and a decrease of the reflected intensity. Accordingly, the temperature instability of the cholesteric color filter is the result of the specific materials which are used. However, at the moment there are no known substitutes for these materials.

Accordingly, the invention relies on the conclusion that in order to prevent oxidation of the dopant, the layer should be separated from air during heating. This is done by adding a barrier coating preventing the ingress of oxygen to the cholesteric color filter. Any type of barrier coating can be used as long as it has the capability of preventing the ingress of air to the extent necessary to prevent degradation of the color filter when heated to temperatures of 180-250° C. for several hours. Suitable coatings can e.g. be made of commercial coat materials, such as materials based on acrylates such as those disclosed and referred to in EP572089. Although thermosetting coating compositions may be used, such compositions have the disadvantage that curing must be done at elevated temperatures, eg at temperatures around 200° C. or even higher. As described hereinabove, exposing the CCF to those temperatures damages the CCF. A way to solve this problem is to perform the curing in an inert atmosphere, eg in nitrogen.

Preferably, in order to avoid that application of the barrier layer itself damages the CCF, the barrier coating is a coating cured by electromagnetic radiation. If desired, an additional heating step could be performed to obtain complete conversion of the polymerization reaction. Although electromagnetic radiation, and especially UV light, is also used for preparation of the cholesteric filter, is does not induce a change in the color filter after stabilization of the color filter has occurred.

In a preferred embodiment of the invention, the barrier coating is a light cured, UV light cured coating.

The cholesteric color filter could be either reflective or transmissive.

Further, the invention relates to a filter, a device and a display using such a cholesteric color filter.

The invention further relates to a corresponding method of manufacturing a cholesteric color filter according to the above, comprising the steps of: arranging a cholesteric color filter on a substrate; covering at least a part of the color filter with a curable coating material; and curing the curable coating material to form a coating, preferably with electromagnetic radiation.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

For exemplifying purposes, the invention will be described in closer detail in the following with reference to embodiments thereof illustrated in the attached drawings, wherein:

FIG. 1 is a diagram illustrating the changes due to heating in transmission spectra for a cholesteric color filter according to the prior art;

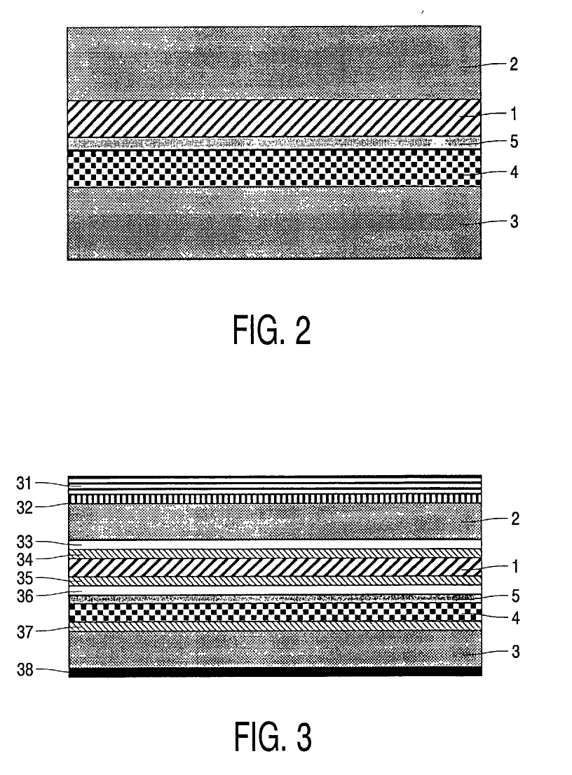

FIG. 2 is a schematic sectional view of a device comprising a cholesteric color filter according to an embodiment of the invention;

FIG. 3 is a schematic sectional view of a device comprising a cholesteric color filter according to a second embodiment of the invention; and

FIG. 4 is a diagram illustrating the changes due to heating in transmission spectra for a cholesteric color filter according to the invention.

FIG. 2 is a schematic, cross-sectional view of a part of a liquid-crystal reflective display device, comprising a display cell comprising e.g. a super twisted nematic (STN) liquid crystal layer 1, essentially being sandwiched between two glass substrates, a front substrate 2 and a back substrate 3. However, the liquid crystal display (LCD) could comprise both passive matrix addressed LCDs and active matrix addressed LCDs. When the LCD is passive matrix addressed the liquid crystal mode is preferably STN (Super Twisted Nematic), but for active matrix addressed displays many liquid crystal modes other than STN could be used, such as TN (Twisted Nematic), ECB and VAN (vertically aligned nematic).

Further, between said highly twisted nematic liquid crystal layer 1 and said back substrate 3, it is arranged a cholesteric color filter 4. The cholesteric color filter conventionally comprises a polymer material having a cholesteric order, and most preferably a photo-isomerizable chiral compound capable of changing the pitch of the cholesteric monomeric material to be polymerized. Accordingly, the cholesteric layer could comprise a polymerized mixture of the isomerizable chiral dopant and a nematic compound. In the above-discussed application, the cholesteric color filter basically combine a reflector function, a polarizer function and a color filter function.

In order to find out the causes of the instability of the cholesteric color filter, various tests were performed. Hereby, the isomerisable dopant by itself was found to decompose during heat treatment. For example, a significant decomposition occurred when heating the dopant at 150° C. for one hour.

The stability of a cholesteric layer, which consists of a polymerized mixture of the isomerizable dopant and a nematic compound, was also tested under various conditions. Not only the temperatures was varied but also the atmospheric conditions. The color filter was heated in air and in a nitrogen atmosphere. It was clearly shown that the blue shift of the color filter is much less in a nitrogen atmosphere than in air.

A blue shift of the wavelength can be a result of a change of the length of the pitch. This decrease of the pitch can result from a decrease of the thickness of the layer. To test this idea the thickness of the layer was measured after heating the layer for several hours. It appeared that the thickness of the layer indeed decreased and this decrease corresponds with the relative decreases of the reflection wavelength.

From these results it was concluded that during heating of the color filter the isomerisable dopant is oxidized, followed by evaporation of reaction products. As a result the structures and orientation of the layer is changed leading to a value shift of the wavelength and a decrease of the reflected intensity.

To alleviate this problem, the cholesteric color filter is further at least partly coated with a barrier coating 5, which is cured by electromagnetic radiation. Preferably, the barrier coating is light-cured, and most preferably UV-cured. Accordingly, after the arrangement of a cholesteric color filter on a substrate, at least a part, and preferably the whole, of the color filter is covered with a coating composition, which is subsequently cured with electromagnetic radiation to obtain the barrier coating 5.

The barrier coating 5 prevents oxidation of the dopant, and maintains the cholesteric color layer separated from air during heating.

Referring now to FIG. 3, a second embodiment of a liquid-crystal reflective display device, comprises a display cell comprising e.g. a super twisted nematic (STN) liquid crystal layer 1, essentially being sandwiched between two glass substrates, a front substrate 2 and a back substrate 3, and a CCF 4, as in the previously discussed embodiment. This embodiment relates to an active matrix LCD, and below the bottom glass substrate 3 a black absorber 38 is arranged. Between the bottom glass substrate 3, the CCF 4, the LC layer 1 and the top glass substrate 2, respectively, PI (poly-imide) alignment layers 34, 35, 37 are arranged. Above the LC layer 1 a TFT (Thin Film Transistor) layer 33 is arranged for driving the LC layer. A transparent and conducting layer, such as an ITO (Indium Tinoxide) layer 36, could further be deposited on the CCF 4 to serve as a counter electrode for the TFT. On top of the panel a linear polarizer 31 and a quarter wave film 32 are applied, which are combined in such a way as to form a circular polarizer. In principle any type of liquid crystal mode could be used in this configuration, as long as the liquid crystal has a retardation of half a wavelength. In case of a passive matrix addressed display, the TFT could be replaced by a patterned ITO layer, and as a counter electrode a second patterned ITO layer could be used.

The barrier coating 5 is preferably arranged directly on top of the CCF, i.e. between the CCF and the ITO layer. In this way the topcoat could also protect the cholesteric layer against oxidation during the ITO deposition.

The cholesteric color filter is preferably made in three steps comprising a coating step and two exposure steps. In the first step the cholesteric monomer mixture is coated on a glass substrate, preferably with a rubbed polyamide layer. The polyamide layer induces the alignment of the mixture. Upon irradiation of the cholesteric layer through a grey-scale mask with UV light of 365 nm the colored pixels can be made. The colors are generated by changing the helical twisting power of the photosensitive dopant by an isomerisation reaction. The dose of UV light, which is necessary to create the right color, is controlled by the grey-scale mask. In the last step the cholesteric structure is stabilized without changing the colors. The color filter is stabilized by a polymerisation reaction between the acrylates in the cholesteric layer, which is induced by UV light of 405 nm. By careful choice of the materials and process circumstances the irradiation processes do not interfere with each other.

In the art, absorptive color filters are often provided with a coating for planarization purposes, such coatings being known as topcoats or overcoats. Such coatings may be suitably used as the barrier coating in the cholesteric color filter of the present invention. Various kinds of such topcoat materials are commercially available, mostly based on acrylates. Commercially available thermosetting topcoat materials require, after deposition of the coating composition, curing at elevated temperatures, in many cases at around 200° C. or even higher. During such heating a polymerization reaction occurs and a stable network of the topcoat materials is formed. However, when applying such a topcoat layer the transmission spectra showed a decrease in reflectance and a blue shift similar to the heating test as described above (FIG. 1). Apparently the heating step necessary to stabilize the topcoat layer still destroys the cholesteric layer. A way around this problem is to perform the heat curing step in an inert atmosphere such as nitrogen.

An alternative solution to the problem is to use a coating composition curable by electromagnetic radiation, such as UV-light, instead of a temperature curable coating composition. In a preferred embodiment, a mixture of HDDA (1,6-hexanediol diacrylate), PETIA (pentaerythritol tri-acrylate), DPGDA (dipropylene glycol diacrylate), Irgacure 651 (photo-initiator) and HQME (inhibitor) is used as the coating composition.

After deposition of the UV curable coating composition the layer could be cured in a nitrogen atmosphere with UV light of 365 nm. After this UV curing step an additional heating step of e.g. 1 hr at 150° C. could be performed to obtain complete conversion of the polymerization reaction. Although UV light of 365 nm is also used for preparation of the cholesteric filter, it does not induce a change in the color filter after stabilization of the color filter has occurred. The transmission spectra in FIG. 4 show that after deposition of a UV curable topcoat the cholesteric color filter is much more stable when heating the sample to 200° C. In FIG. 4, the lowermost curve with the greatest thickness indicates the transmission spectra for the CCF with a barrier coating before heating, whereas the higher and thinner curves in order represents the transmission spectra for CCF:s heated 1 hr, 2 hr, 4 hr and 6 hr, respectively.

Since the barrier coating is obtained by curing using electromagnetic radiation, it can be manufactured below the decomposition temperature of the photo-isomerizable chiral compound. Thus, the barrier coating prevents degradation of the color filter which occurs during the high temperature steps of the subsequent manufacturing process, such as the deposition of an ITO-layer, curing of poly-imide alignment layers, and the like.

The barrier coating does not only prevent the isomerisable dopant from oxidation during heat treatment, but in principle also the other components of the cholesteric layer, such as the liquid crystal host.

Thus, the stability of the cholesteric color filter is improved by addition of such a barrier coating, which is a great advantage for applications such as in LCDs.

The invention has in the above been described in a LCD-application. However, the invention is useful in other applications using cholesteric color filters as well, such as in other types of electro-optical display devices, in charge coupled devices (CCD) for picking up pictures, etc. Further, the cholesteric color filter could be of either reflective or transmissive type. Still further, the barrier coating could be of any kind that protects the cholesteric color filter against degradation in subsequent manufacturing steps. It is also possible to use a barrier coating which is curable by other kinds of electromagnetic radiation than UV-light.

Such obvious modifications must be considered to be with in the scope of the invention as it is defined in the appended claims.

1. A cholesteric color filter comprising a barrier coating for preventing the ingress of oxygen.

2. A cholesteric color filter as in claim 1, characterized in that the barrier coating is a coating cured by electromagnetic radiation.

3. A cholesteric color filter according to claim 1 or 2, wherein the barrier coating is cured with light, preferably UV light.

4. A reflector comprising a cholesteric color filter according to claim 1, 2 or 3.

5. A transmissive filter comprising a cholesteric color filter according to claim 1, 2 or 3.

6. A cholesteric color filter according to any one of the claims 1-3, wherein the cholesteric color filter comprises a polymer material having a cholesteric order.

7. A method of manufacturing a cholesteric color filter characterized in the steps of:
arranging a cholesteric color filter on a substrate;
covering at least a part of the color filter with a curable coating composition; and
curing the curable coating composition, preferably with electromagnetic radiation.

8. A method according to claim 7, wherein the curable coating composition is cured with light, and preferably UV-light.

9. A method according to claim 7 or 8, wherein an additional heat curing of the curable coating composition is performed after the curing with electromagnetic radiation.

10. A method according to any one of the claims 7-9, wherein the curing step is performed in a nitrogen atmosphere.

11. A device comprising a filter according to any one of the claims 1-6.

12. A display device comprising a display panel, such as a liquid crystal display, and a cholesteric color filter according to any one of the claims 1-6.
